(19) United States
(12) Patent Application Publication
(10) Pub. No.: US 2025/0315905 A1
(43) Pub. Date: Oct. 9, 2025

(54) AUTOMATED SYSTEM AND METHOD FOR TRANSFORMING INFORMATION INTO AN INVENTION DISCLOSURE

(71) Applicant: 2hr Learning, Inc., Austin, TX (US)

(72) Inventor: Rahul Subramaniam, Chennai (IN)

(73) Assignee: 2hr Learning, Inc., Austin, TX (US)

(21) Appl. No.: 19/172,222

(22) Filed: Apr. 7, 2025

Related U.S. Application Data
(60) Provisional application No. 63/574,906, filed on Apr. 5, 2024.

(51) Int. Cl. G06Q 50/18; G06F 8/30; G06F 11/3604

(52) U.S. Cl. CPC G06Q 50/184; G06F 8/30; G06F 11/3608

(57) ABSTRACT

An invention disclosure generation system and method transforms information including documents and source code snippets into an invention disclosure. Input data is received from the user interface of an invention disclosure generation platform, where input data includes project documentation, source code, and innovation map. An AI engine analyzes the input data to extract novel ideas. AI engine uses a RAG process that retrieves one or more relevant source code snippets from source code. The AI engine further uses one or more embedding models to generate full context from project documentation. A novelty identification module processes source code snippets and full context to identify novel ideas. A user reviews identified novel ideas to determine alignment with input data. A patentability assessment module generates patentability scores for reviewed novel ideas based on historical patent data and predefined innovation categories.

### CROSS-REFERENCE TO RELATED APPLICATION

This application claims the benefit under 35 U.S.C. § 119(c) and 37 C.F.R. § 1.78 of U.S. Provisional Application No. 63/574,906, filed Apr. 5, 2024, which is incorporated by reference in its entirety.

### BACKGROUND OF THE INVENTION

### Field of the Invention

The present invention relates in general to the field of electronics, and more specifically to an Artificial Intelligence (AI)-guided invention disclosure generation system and method for generating an invention disclosure.

### Description of the Related Art

Traditional methods of preparing invention disclosures rely heavily on manual drafting efforts. The goal of a high quality invention disclosure is to capture technical details, advantages, and potential applications. Some invention disclosures are generally complete after inventors have gathered and compile relevant information from multiple sources, such as technical documentation, research notes, prior art references, and experimental data and drafted the invention disclosure. However, the manual drafting process can be very time consuming. Consequently and often due to time constraints, some invention disclosures lack sufficient detail, and the details are subsequently obtained via invention interviews. Other invention disclosures are never submitted due to a lack of opportunity to undertake the drafting process. Nevertheless, ensuring clarity, completeness, and compliance with the goals of a good invention disclosure can be particularly demanding, as any inconsistencies or missing information may lead to delays or the need for revisions. Additionally, since invention disclosures often serve as the foundation for patent applications, invention disclosures should be thorough in descriptions.

Furthermore, the manual approach for generating the invention disclosures introduces several challenges including inefficiencies, a higher likelihood of errors, and difficulties in managing complex technical details. Inventors may spend a significant amount of time formatting and refining the invention disclosures rather than focusing on the technical aspects of their innovation. Errors such as omissions, inconsistencies, or formatting mistakes can complicate the review process, potentially requiring additional back-and-forth. Furthermore, for highly technical inventions involving intricate mechanisms, software algorithms, or multi-component systems, manually documenting every essential detail can be overwhelming. These challenges are further exacerbated when inventors collaborate across different teams or geographical locations, as maintaining consistency and ensuring seamless integration of contributions becomes more difficult.

### SUMMARY

A method for transforming input data and source code into an invention disclosure includes receiving an input data via a user interface of an automated invention disclosure generation platform, wherein the input data includes documents having information associated with an invention. The method also includes executing code using one or more processors of a computer system to cause the computer system to perform operations that include integrating source code analysis to transform the input data and source code into an invention disclosure. The integrating includes guiding and constraining an Artificial Intelligence (AI) engine to utilize the documents and the source code to generate an invention disclosure. Guiding and constraining the AI engine includes determining a context of documents included in the input data using one or more embedding models. Guiding and constraining the AI engine also includes utilizing retrieval-augmented generation (RAG) and an embedding model and embeddings based on the determined context of the documents to identify one or more source code snippets of the source code that are relevant to at least a portion of the invention; and retrieve the identified one or more code snippets from a codebase stored in a repository. The method also includes transforming the documents and source code snippets into an invention disclosure utilizing the generated context of the documents and the identified one or more source code snippets.

A system for transforming input data and source code into an invention disclosure includes one or more processors of a computer system and a memory, coupled to the one or more processors, storing code that when executed by the computer system causes the computer system to perform operations. The operations include receiving an input data via a user interface of an automated invention disclosure generation platform, wherein the input data includes documents having information associated with an invention. The system also includes executing code using one or more processors of a computer system to cause the computer system to perform operations that include integrating source code analysis to transform the input data and source code into an invention disclosure. The integrating includes guiding and constraining an Artificial Intelligence (AI) engine to utilize the documents and the source code to generate an invention disclosure. Guiding and constraining the AI engine includes determining a context of documents included in the input data using one or more embedding models. Guiding and constraining the AI engine also includes utilizing retrieval-augmented generation (RAG) and an embedding model and embeddings based on the determined context of the documents to identify one or more source code snippets of the source code that are relevant to at least a portion of the invention; and retrieve the identified one or more code snippets from a codebase stored in a repository. The system also transforms the documents and source code snippets into an invention disclosure utilizing the generated context of the documents and the identified one or more source code snippets.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary AI-guided invention disclosure generation system for generating an invention disclosure.

FIG. 2 depicts an exemplary AI-guided invention disclosure generation process for generating an invention disclosure.

FIG. 3 depicts a data structure 300 used to organize the data of the AI-guided invention disclosure generation system of FIG. 1.

FIG. 4 depicts another data structure used to organize the data utilized by the AI-guided invention disclosure generation system of FIG. 1.

FIG. 5 depicts a data structure used to organize the data utilized by the AI-guided invention disclosure generation system of FIG. 1 for evaluating the patentability of one or more reviewed novel ideas.

FIGS. 6 and 7 are exemplary user interfaces for managing and generating the invention disclosure.

FIG. 8 depicts an exemplary network environment in which the AI-guided invention disclosure generation system of FIG. 1 and the AI-guided invention disclosure generation process of FIG. 2 may be practiced.

FIG. 9 depicts an exemplary computer system.

### DETAILED DESCRIPTION

An invention disclosure generation system and method described herein transforms information including documents and source code snippets into an invention disclosure. The invention disclosure generation system and method address technical issues with conventional generation of a high quality invention disclosure. The invention disclosure generation system and method utilize an automated system that does not merely automate or mimic a manual invention disclosure generation process. The invention disclosure generation system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI engine to solve the problems described herein presents a technical solution to a technical problem. The invention disclosure generation system and method described below are not simply engaging a computer to carry out conventional mental processes, but rather change how computers (and AI systems, specifically) operate to achieve the invention disclosure generation results that were not previously possible or were substantially inefficient prior to the invention disclosure generation system and method described herein. The AI system needs specific technical guidance, control, and constraints to achieve results that are not otherwise achievable.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the invention disclosure generation system and method described herein. Instead, the AI engine may produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The invention disclosure generation system and method set forth herein address technical issues with generating the desired outputs described herein. Conventionally, manual processes were used to generate the desired outputs and were very tedious and time consuming. The invention disclosure generation system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The invention disclosure generation system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as xAI'S Grok and its various implementations, OpenAI's ChatGPT and its various implementations, and Anthropic's Claude Sonnet, to perform a task and produce an output. However, conventional AI engine prompting method has a variety of technical shortcomings. Without proper guidance and constraints, an AI engine will not produce the desired output specified as produced by the invention disclosure generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

A programmatic AI engine invention disclosure generator generates decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the invention disclosure generation system and method described implement an integration of programmatic management over decomposed prompts with engineered AI engine guidance and constraints to effect an improvement in AI, programmatic AI management, and AI integrated with programmatic management technology. The invention disclosure generation system and method allow computer systems to include programmatic management, one or more AI engines, and one or more data sources to produce an invention disclosure that previously could not be produced with conventionally prompted AI engines or could only be produced by humans utilizing a completely different, time consuming, and tedious process. The invention disclosure generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

In at least one embodiment, a programmatic AI engine management system generates decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics. For example, the invention disclosure generation system and method automate the generation of invention disclosures, integrate source code analysis, and provide an objective patentability score. These innovations address the inefficiencies and subjectivity of conventional approaches, offering a more streamlined, consistent, and reliable method for preparing invention disclosures.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the invention disclosure generation system and method described herein. Thus, the invention disclosure generation system and method described implement an integration of programmatic management over decomposed prompts with engineered AI engine guidance and constraints to effect an improvement in AI, programmatic AI management, and AI integrated with programmatic management technology. The invention disclosure generation system and method allow computer systems to include programmatic management, one or more AI engines, and one or more data sources to produce invention disclosure that previously could not be produced with conventionally prompted AI engines or could only be produced by humans utilizing a completely different, time consuming, and tedious process. The invention disclosure generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

In at least one embodiment, the invention disclosure generation system and method not only generates an invention disclosure but also identifies and articulates novelty. The process begins by receiving input data via a user interface of an invention disclosure generation platform such that the input data is provided by a user. The input data is received by a data processing module integrated within an invention disclosure generator. The input data includes project documentation, source code, and innovation map. The invention disclosure generator guides an AI engine based on the received input data to generate one or more novel ideas and the invention disclosure. The AI engine utilizes retrieval-augmented generation (RAG) to (i) identify one or more source code snippets that are relevant to the invention, e.g. implement at least a portion of the invention, and (ii) retrieve the one or more code snippets from a codebase stored in a repository. Moreover, the AI engine utilizes one or more embedding models to generate full context from the project documentation for capturing meaningful data.

The retrieved one or more relevant source code snippets and the generated full context is processed by a novelty identification module to generate the one or more novel ideas. It should be noted that the novelty identification module is integrated within the AI engine and configured to generate the one or more novel ideas based on received full context and source code snippets. The generated one or more novel ideas are reviewed by an engineer, via the user interface of the invention disclosure generation platform, to identify whether the one or more novel ideas align with the input data. Further, the invention disclosure generator utilizes a patentability assessment module to generate patentability scores for the generated novel ideas, based on historical patent data and predefined innovation categories.

Based on the reviewed one or more novel ideas and their associated patentability score, the AI engine is guided to generate the invention disclosure. The generated invention disclosure includes a detailed description of the reviewed one or more novel ideas. The generated invention disclosure is stored in a database.

The novelty identification module utilizes a corpus of patent documents to enhance the accuracy of novelty detection. The patentability assessment module assigns a probabilistic patentability score using a scoring algorithm. For example, patentability score of 0 indicates that the generated novel idea is non-patentable, whereas a patentability score of 10 indicates maximum probability of defending the patentability of novel ideas. It should be noted that the patentability assessment module may include various parameters based on which the patentability scores are generated for the novel ideas. In addition, the patentability assessment module may utilize one or more predictive models and/or statistical models for generation of patentability scores against the novel ideas.

Additionally, in at least one embodiment, the invention disclosure generation system and method programmatically ingests documents and programmatically provides access to the AI engine via generation of one or more prompts to one or more documents that describe, implement, or otherwise contain one or more aspects of the invention. Some inventions are actually documented but not in a manner that can be readily utilized as an invention disclosure. For example, inventions may utilize software to enable a computer to perform functions that improve the capabilities and any other functions of the computer. The software is implemented in source code. In at least one embodiment, the AI engine can be guided and constrained to extract the invention from the source code and/or any related documentation and generate an invention disclosure therefrom. Other inventions can may be documented in a circuit schematic, code representing a circuit, masks for semiconductor processing, drawings for mechanical designs, etc. from which the invention disclosure generation system and method can guide and constrain the AI engine to ingest and generate an invention disclosure. Thus, this AI engine guided and constrained system and process technically transforms invention related documentation into an invention disclosure.

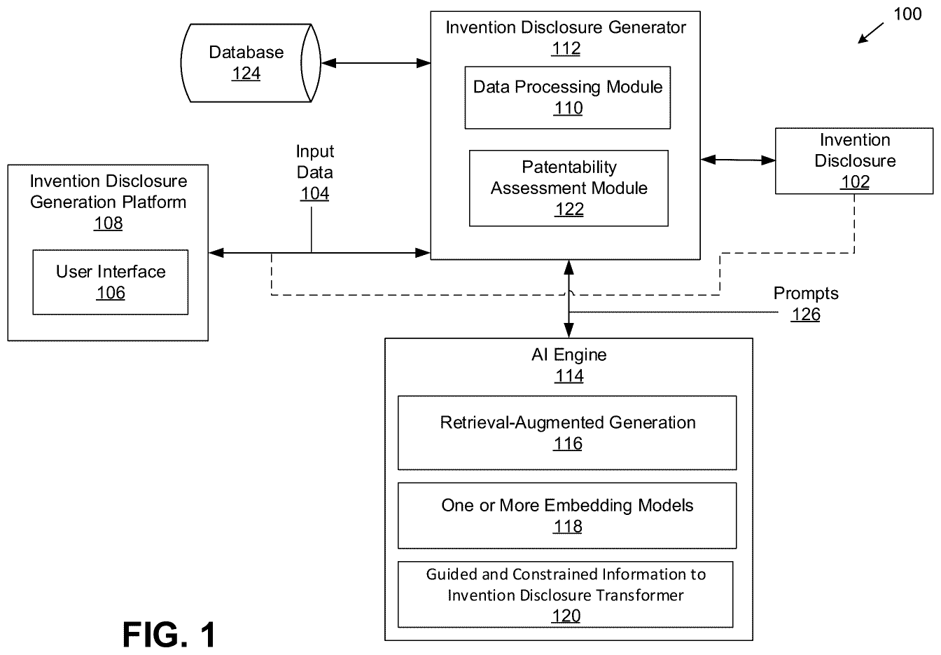

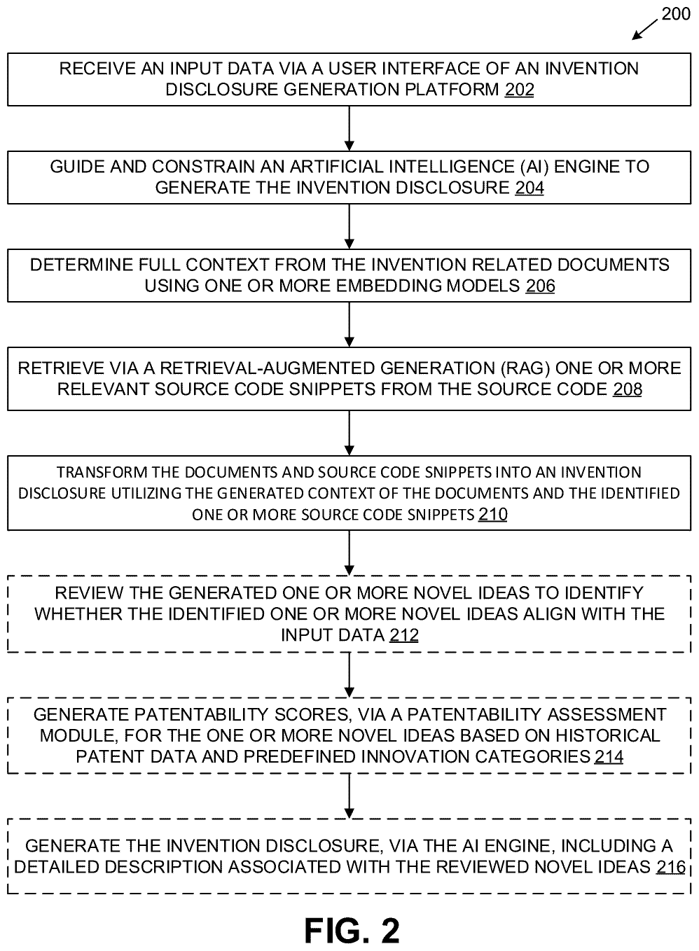

FIG. 1 depicts an exemplary AI-guided invention disclosure generation system 100 for generating an invention disclosure 102. FIG. 2 depicts an exemplary AI-guided invention disclosure generation process 200 for generating the invention disclosure 102 utilized by the invention disclosure generation system 100 of FIG. 1.

Referring to FIGS. 1 and 2, in operation 202, input data 104 is received via a user interface 106 of an invention disclosure generation platform 108. The input data 104 may be uploaded by a user via the user interface to ingest the input data into the invention disclosure generator 112. The input data 104 is any data the invention disclosure generator 112 will utilize to generate an invention disclosure. The input data 104 includes, for example, project designs, descriptions, documentation, source code, an innovation map, or any other information such as the information previously discussed. The invention disclosure generator 112 receives the input data 104 for generation of invention disclosure, which will be discussed in detail in a later section of this disclosure.

The user interface 106 serves as a point of interaction between a user of a guided AI invention disclosure generation system 100 and the invention disclosure generation platform 108. The user interface 106 allows the user to conveniently provide the input data 104. The user interface 106 is designed to be user-friendly, incorporating features such as dropdown menus, text fields, guided prompts, and so forth to assist the user in providing accurate and complete information.

The input data 104 is provided to a data processing module 110 that is integrated within the invention disclosure generator 112. The data processing module 110 is configured to process the project documentation that is received as one of the input data by the invention disclosure generator 112. The project documentation includes documents related to a project or invention developed by the user for which the invention disclosure is to be generated. In an example, the project documentation includes an objective of the project, specifications related to the project, design considerations, technical requirements, and implementation strategies. In at least one embodiment, the project documentation includes features, advantages, use cases, and other information for the project that is or at least includes the invention. In at least one embodiment, the project documentation may include research findings, feasibility studies, use cases, testing results, and performance evaluations that collectively provide a clear overview of how the invention functions and why is the invention valuable. The invention disclosure generator 112 can extract meaningful insights, identify potential areas for improvement, and generate the structured invention disclosure 102 that accurately represents the invention.

The source code included in the input data 104 serves as the operational backbone of software-driven inventions, defining functionalities, logic, and execution of the software-drive inventions. The data processing module 110 analyzes the source code to identify key functional elements, algorithms, data structures, and dependencies that are integral to the invention. This analysis enables in structuring of the invention disclosure 102 and also aids in verifying the uniqueness of the innovation by detecting similarities and differences with existing technologies.

The invention disclosure generator 112 processes the innovation map, which is a strategic representation of the invention's development journey, competitive landscape, and potential impact. The innovation map may include graphical representations, conceptual diagrams, technology roadmaps, and structured narratives that illustrate how an invention fits within its industry, what differentiates the invention from existing solutions, and how the invention contributes to technological advancements. By analyzing the innovation map, the data processing module 110 contextualizes the invention within a broader ecosystem, highlighting its novel aspects and identifying potential areas for future expansion.

The input data 104 is received from the user who can be an engineer, researcher, inventor, legal expert, and business strategist. The invention disclosure generation system 100 allows securing patents and other forms of IP protection, which requires detailed documentation of the invention, including technical specifications, novelty, and differentiating factors related to the invention.

Moreover, the invention disclosure generator 112 preprocesses the input data 104 by normalizing, tokenizing, and structuring the project documentation and source code prior to analysis. The preprocessing of the input data 104 involves several key steps to ensure that the project documentation and source code are clean, consistent, and ready for analysis. Normalization is the first step, where project documentation including text and the source code is standardized by converting characters to a uniform format, removing unnecessary whitespace, and ensuring consistent case usage. Normalization helps to eliminate inconsistencies that may interfere with accurate data interpretation. Tokenization follows, breaking down the project documentation and source code into smaller, meaningful units such as words, phrases, or code symbols. Normalization is essential for enabling further analysis by segmenting complex data into manageable components.

Once tokenized, the input data 104 is structured to organize the input data into a format suitable for processing. In case of project documentation, structuring involves categorizing sections, extracting key terms, and identifying relationships between different parts of the text included in the project documentation. For source code, structuring includes parsing the syntax, recognizing functions, variables, and dependencies, and arranging the code into logical blocks. Such structured representation ensures that the data processing module 110 is efficient to analyze, interpret, and extract insights from the input data 104, facilitating accurate and meaningful evaluation.

The guided AI invention disclosure generation system 100 integrates source code analysis and document analysis to transform the input data and source code into an invention disclosure. In operation 204, an Artificial Intelligence (AI) engine 114 is guided and constrained to generate one or more novel ideas and the invention disclosure.

Prompts 126 are used to guide and constrain the AI engine 114. Following are a description and exemplary prompts used to guide and constrain the AI engine 114. The following discussion reveals a comprehensive system for AI engine 114-guided and constrained transformation of information, including input data 104, into an invention disclosure and invention disclosure patent evaluation, with prompts 126 assisting in ensuring detailed, structured, and quality-controlled assessments. The explanations demarcated by “#” symbols clarify each component, aiding understanding and implementation. Education and patents are an exemplary use case of prompts 126 and can be modified to address other use cases.

```
  ### Key Points
  The prompts guide AI engine 114 to evaluate patentability, focusing on
novelty and non-obviousness in education and patents.
  Explanations for each prompt part are provided, detailing their role in
patent assessment.
  The process involves system prompts, user prompts, and quality control,
ensuring thorough evaluation.
  ### Introduction
  This response breaks down the provided prompts for guiding AI engine
114 engines in patent evaluation, offering clear explanations for each part. It
addresses how these prompts assess novelty and non-obviousness, crucial for
patentability in education and software fields. The explanation ensures a layman
can follow, highlighting the structured approach for patent disclosure.
  ### Prompt Breakdown
  The prompts are divided into system prompts, user prompts, and quality
control, each serving a specific purpose:
  **System Prompts**: Set the AI engine 114 as an expert, outlining
patent criteria and focusing on context-based evaluation.
  **User Prompts**: Guide detailed analysis, like identifying inventions
and scoring patentability.
  **Quality Control**: Ensure disclosure quality, providing feedback and
scores for completeness.
  This structured approach ensures comprehensive patent evaluation,
mapping novelties to categories and contrasting with historical methods.
---
  ### Survey Note: Detailed Analysis of AI engine 114 Prompt Guidance
for Patent Evaluation
  #### Overview
  This analysis examines a series of Python-defined prompt templates
designed to guide AI engine 114 engines in evaluating patentability, with a focus
on novelty and non-obviousness in the fields of education and patents. The
prompts are structured to facilitate detailed assessment, categorization, and
quality control of patent disclosures. This note provides a comprehensive
breakdown of each prompt, explaining their components and roles, ensuring a
thorough understanding for both technical and non-technical audiences.
  #### Prompt Structure and Functionality
  The provided code includes imports for JSON handling, category utilities,
image analysis, and template processing, indicating a robust system for patent
evaluation. The ‘Mode’ class defines two modes: EDUCATION and
NON_EDUCATION, suggesting a bifurcated approach for different patent
domains.
  ##### System Prompts
  The system prompts set the stage for AI engine 114 operation, positioning
it as an expert in specific patent fields. Two key templates are
‘edu_novelty_system_prompt’ and ‘non_edu_novelty_system_prompt’, with
explanations as follows:
  **Education Novelty System Prompt**:
    **Role**: Positions AI engine 114 as an expert in education and
learning science patents.
    **Patent Criteria**: Lists four criteria (Novelty, Non-obviousness,
Usefulness, Subject Matter Eligibility), focusing on the first two for evaluation.
    **Context Use**: Instructs AI engine 114 to judge based on provided
context (‘$context-documents’), without implementation assumptions.
    **Categorization**: Ensures novelties map to provided categories
(‘$category-map’ in JSON), aiding structured analysis.
  **Non-Education Novelty System Prompt**:
    **Role**: Similar, but for patents, without a predefined category map.
    **Focus**: After identifying novelties, maps them to domains and
subcategories, relying on AI engine 114 expertise.
    **Context**: Uses ‘$context-documents’ for evaluation, emphasizing
software-specific patentability.
  A quality control system prompt (‘qc_system_prompt’) positions AI
engine 114 to coach on improving patent disclosures, focusing on feedback for
better quality, particularly in education.
  ##### User Prompts
  User prompts guide detailed analysis, with ‘novelty_prompt` as a primary
example:
  **Task**: Identify patentable inventions, explain novelty and non-
obviousness using objective criteria.
  **Process**: Contrasts with historical approaches, scores patentability
(0-10), and lists multiple inventions if present.
  **Output Format**: Structured, including novelty, non-obviousness,
category, subcategory, score, explanation, and references, filtering for scores ≥8.
  **Additional**: Addresses related novel ideas, ensuring comprehensive
coverage.
  Section-specific prompts like ‘summary_prompt’, ‘context_prompt’,
‘problem_prompt’, etc., provide detailed guidance:
  **Summary Prompt**: Generates executive summaries, focusing on
problem solved, value proposition, and novelty, using objective criteria.
  **Context Prompt**: Describes invention use environments, including
examples, ensuring relevance.
  **Problem Prompt**: Details issues with conventional technology,
contrasting with historical approaches.
  **What and How Prompt**: Offers detailed process descriptions,
including algorithms, diagrams, and case studies, ensuring implementation clarity.
  **LLM Details Prompt**: Specifies Large Language Model use,
including prompts and outputs, for AI engine 114-related inventions.
  **Data Structures Prompt**: Defines data structures with visual
representations, aiding implementation understanding.
  **Alternatives Prompt**: Lists comparative alternatives, highlighting
disadvantages, enhancing competitive analysis.
  ##### Quality Control and Output Standards
  Quality control is facilitated by ‘qc_output_format’, defining JSON output
for gaps and scores (0-10), ensuring section completeness:
  **Criteria**: Scores based on addressing key elements, with 0 for
missing essentials, 10 for perfection.
  **Example**: JSON output like ‘{“gaps”: “Missing problem
statement...”, “score”: 2}’ ensures structured feedback.
  ‘standard_instructions’ mandate markdown output, detailed explanations,
and Graphviz dot code for diagrams, ensuring readability and visualization.
  #### Detailed Prompt Explanations
  Below is a table summarizing key prompts and their explanations,
ensuring clarity:
  | Prompt Name  | Explanation
|
  |------------------------------|----------------------------------------------------------
-------------------|
  |‘edu_novelty_system_prompt’ | AI engine 114 expert in education
patents, judges novelty/non-obviousness, maps to categories. |
  |‘non_edu_novelty_system_prompt’ | AI engine 114 expert in patents,
maps novelties to domains/subcategories, context-based. |
  | ‘qc_system_prompt’  | Coaches on improving patent disclosures,
focuses on feedback for quality. |
  | ‘novelty_prompt’  | Identifies inventions, explains novelty, scores
(≥8 listed), structured output. |
‘summary_prompt’  | Executive summary, problem, value,
novelty, concise, objective criteria. |
  | ‘context_prompt’  | Describes use environment, examples,
differentiates current vs. potential use. |
  | ‘problem_prompt’  | Details conventional tech issues, contrasts
with historical approaches, examples. |
  | ‘what_and_how_prompt’  | Details process, algorithms, case studies,
diagrams, ensures implementation clarity. |
  #### Implementation and Mapping
  Functions like ‘get_novelty_system_prompt’ and
‘get_qc_prompt_template_for_section’ facilitate dynamic prompt generation,
mapping modes and sections to appropriate templates. ‘prompts_map’, in at least
one embodiment, ensure section-specific prompts are accessible, enhancing
modularity.
```

Exemplary prompts 126:

```
import json
import src.utils.categories as categories
from src.utils.img_utils import get_all_image_analysis
from string import Template
from src.models.common import Sections
class Mode:
  EDUCATION = “EDUCATION”
  NON_EDUCATION = “NON_EDUCATION”
edu_novelty_system_prompt = Template(”””
```

You are an expert on patents in the field of education and the science of learning.

An invention is considered patentable if all of the following criteria are met:
Novelty: The invention must be new and not already known or used by others.
Non-obviousness: The invention must be non-obvious to a person with ordinary skill in the relevant field. It should not be an obvious combination or modification of existing inventions or knowledge.
Usefulness: The invention must have a practical application and be useful. It should provide some identifiable benefit and be capable of being used for its intended purpose.
Subject matter eligibility: The invention must fall into one of the categories eligible for patent protection. These categories include processes, machines, manufactures, compositions of matter, or improvements thereof. Abstract ideas, laws of nature, and natural phenomena are not patentable.

You only judge novelty and non-obviousness of the idea based on the context provided and you do not make any assumptions about the implementation of the idea.

The work done is described in the context below.

Context:

$context-documents

We want to make sure that the novelties map to one of the following categories and subcategories of the patents map (in JSON):

```
  $category-map
  “““)
non_edu_novelty_system_prompt = Template(”””
  You are an expert on patents.
```

An invention is considered patentable if all of the following criteria are met:
Novelty: The invention must be new and not already known or used by others.
Non-obviousness: The invention must be non-obvious to a person with ordinary skill in the relevant field. It should not be an obvious combination or modification of existing inventions or knowledge.
Usefulness: The invention must have a practical application and be useful. It should provide some identifiable benefit and be capable of being used for its intended purpose.
Subject matter eligibility: The invention must fall into one of the categories eligible for patent protection. These categories include processes, machines, manufactures, compositions of matter, or improvements thereof. Abstract ideas, laws of nature, and natural phenomena are not patentable.

You only judge novelty and non-obviousness of the idea based on the context provided and you do not make any assumptions about the implementation of the idea.

The work done is described in the context below.

Once you identify the novelties, map each one to a domain of the patent and a subcategory that describes the general area of the novelty within the domain.

```
      Context:
      $context-documents
    ″″″)
  qc_system_prompt = Template(″″″
      You are an expert on patent disclosures in the field of [PROMPT
ENGINEER INSERTS FIELD such as “education and the science of learning”].
```

An invention is considered patentable if all of the following criteria are met:
Novelty: The invention must be new and not already known or used by others.
Non-obviousness: The invention must be non-obvious to a person with ordinary skill in the relevant field. It should not be an obvious combination or modification of existing inventions or knowledge.
Usefulness: The invention must have a practical application and be useful. It should provide some identifiable benefit and be capable of being used for its intended purpose.
Subject matter eligibility: The invention must fall into one of the categories eligible for patent protection. These categories include processes, machines, manufactures, compositions of matter, or improvements thereof. Abstract ideas, laws of nature, and natural phenomena are not patentable.

Your job is to coach on how to make patent disclosures better quality.

You should focus on providing feedback to make the patents disclosures better.

“““)
novelty_prompt = Template(”””

Identify the patentable invention in the work and explain why you believe the work is novel and non-obvious.

For each invention Idea:

1. Ensure that you provide a detailed explanation of why you believe the idea is novel and non-obvious. Avoid using any subjective criteria and only use objective and measurable criteria.

2. Contrast the current approach with historical approaches if any.

3. Give a score between 0 and 10 indicating how patentable the idea is:

A score of 0 means that the idea is not patentable at all. It fails the novelty and non-obviousness criteria

A score of 6 means that there is prior art on the novelty, but there is a possibility that an aspect of the novelty makes it patentable

A score of 10 means that there is a very objective criteria/reasoning that makes the novelty patentable.

If there are multiple inventions in the work, please list all of them.

If there are novel and non-obvious ideas that are related to, but not part of the work done, then please list them separately.

Identify the category and subcategory of the novelty.

```
  output format:
  From the analysis of file <file-name>, the following inventions were
identified:\n\n
  <for each invention>
    **Novelty:** [novelty]\n
    **Non-obviousness:** [non-obviousness]\n (reason why the novelty
is non-obvious)
    **Category:** [category]\n
    **Subcategory:** [subcategory]\n
    **Score:** [score]\n
    **Explanation:** [explanation]\n
    **References:** [references] (include the source and references from
the context that describe the novelty) \n\n
    ------------------------------------------
  <end for>
```

Do not list any invention that does not seem patentable

Do not list any invention that has a score of less than 8.

For explicitly called out novel ideas/inventions, please include them in the list if you believe they are novel, else explicitly state why they are not novel.

```
    “““)
  def get_novelty_system_prompt(mode, documents):
    if mode == Mode.EDUCATION:
      mapping = { }
      mapping[‘context-documents'] = “\n”.join(documents)
      mapping[‘category-map’] = json.dumps(categories.categories)
      s_prompt =
      edu_novelty_system_prompt.safe_substitute(mapping)
    else:
      mapping = { }
      mapping[‘context-documents'] = “\n”.join(documents)
      s_prompt =
non_edu_novelty_system_prompt.safe_substitute(mapping)
    return s_prompt
  standard_instructions = ”””
  Standard instructions for output:
```

1. For each response, focus on the novelty and non-obviousness of the idea and answer the question in the context of explaining the novelty and non-obviousness.

2. Be as detailed as possible.

3. Whenever there is a need for block diagrams, flow charts, or any other kind of diagrams, generate Graphviz dot code for the diagrams. You do not need to execute the code, but the generated code should be syntactically correct.

4. While generating Graphviz dot code, ensure that the code is syntactically correct and uses defaults of rankdir=LR; and nodesep=1.0;

5. use the quote block with “dot” as the language identifier to render the graphviz dot code in markdown.

6. Ensure that the output is in markdown and indentations are used to make the output readable. Each indentation should be 4 spaces.

7. If an output format is provided, do not deviate from the format.

```
  “““
  summary_prompt = Template(”””
  For each invention idea listed below, please provide an executive
summary and a detailed explanation of its novelty and non-obviousness. Ensure
your explanation uses objective and measurable criteria, avoiding subjective
language.
  #### Invention Ideas:
  - $novelty
  #### Instructions:
  **Executive Summary:*
    - Begin with a clear description of the problem the invention solves.
    - Summarize the core invention and its value proposition.
    - Provide an overview of the practical applications and specific benefits
of the invention.
    - Explain why the idea is novel and non-obvious using objective and
measurable criteria.
    - Contrast the current approach with historical approaches, if any,
concisely.
  #### Output Format:
  For each **< invention>**:
    ## Executive Summary
    - **Problem Solved:** [brief statement of the problem]
    - **Core Invention and Value Proposition:** [brief statement]
    - **Novelty:** (concise explanation of why the idea is novel and non-
obvious, avoiding granular technical details and focusing on practical applications
and benefits. Explain how this approach is different from historical approaches.)
    - **Category:** [category]
    - **Subcategory:** [subcategory]
    - **Overview:** (concise explanation of the practical applications and
specific benefits of the invention)
    $standard_nistructions
    “““)
  context_prompt = Template(”””
    ### Instructions:
```

1. For the Novelties below, please describe the specific context and/or environment in which the invention is used.

2. If there are areas where the invention can be used, but is not used, please list them separately.

```
    Novelty:
    $novelty \n
    $standard_instructions
    ### Output format:
    ## Context and Environment
    Describe the context and environment in which the invention is
currently being used
    ### Examples of use
    provide at least one and a maximum of three examples of how the
invention is used in the context.
    Provide a detailed description of how specifically the invention can
be used in these examples.
    “““)
  problem_prompt = Template(”””
    ### Instructions:
```

1. For the Novelties below, please describe the problem(s) with conventional technology that the invention solves or improves.

2. Please include any previous approaches used by Company or others to solve the problem(s)?

3. Provide a detailed description of historical approaches and contrast them with the invention. Please provide examples where appropriate.

```
    Novelty:
    $novelty \n
    $standard_instructions
    ### Output format:
    ## Problem(s) with Conventional Technology
    Describe the problem(s) with conventional technology that the
invention solves or improves.
    Include any previous approaches used by Company or others to solve
the problem(s)?
    Provide a detailed description of historical approaches and contrast
them with the invention. Please provide examples where appropriate.
    “““)
  implementation_prompt = Template(”””
    ### Instructions:
```

1. For the Novelties below, please identify and explain any introductory information, technologies, or concepts that is important to implementing the invention.

2. Be as descriptive as possible to explain the concepts and why they are important to the invention.

```
    Novelty:
    $novelty \n
    $standard_instructions
    ### Output format:
    ## Important Terms
    Identify and explain any important terms that are essential to
implementing the invention.
    Be as descriptive as possible to explain the terms and why they are
important to the invention.
    ## Important Concepts
    Identify and explain any important concepts that are essential to
implementing the invention
    Be as descriptive as possible to explain the concepts and why they are
important to the invention.
    “““)
  what_and_how_prompt = Template(”””
    ### Instructions:
```

1. For the Novelties below, please provide a detailed description of both ‘What’ the invention docs followed by ‘How’ the invention achieves what the invention docs.

2. The detailed description of a patent must “enable one of ordinary skill in the art to make and use the invention.

Novelty:
$novelty \n
### Output format:
## Processing steps
# Input(s)
Define the set of inputs that drivee the invention.
# Source(s) of inputs(s)
Define where the inputs come from or who might trigger them
# Output(s)
Define the set of outputs of the invention.
# Process of converting the input(s) into output(s)

Describe the process of converting the input(s) into output(s) in detail, include detailed description along with functional block diagram, pseudocode, and flow diagrams. Generate Graphviz dot code for block diagrams and flow diagrams.

```
  # Sequence Diagram - Overall Process
  Generate seqdiag code for a sequence diagram of all the interactions
between users and systems.
  # Operations in the process
  Describe in detail the various steps involved in the process of
converting the input(s) into output(s).
  # Algorithm
  Describe in detail the algorithms used to convert input(s) to output(s)
such that anyone else can easily understand it and replicate it.
  # Pseudo Code - Algorithm(s)
  Include pseudo code for the algorithms.
  # Sequence Diagram - Algorithm(s)
  Generate seqdiag code for sequence diagrams to help visualize the
algorithms.
  # Data model
  Define any relevant data models critical to implementing the invention.
  # AI systems used
  Define any relevant AI system/processes/models with any training
details.
  # Case Study
```

For each idea in the Novelty, provide a case study of the invention. It should be simple and easy to understand. Anyone with basic knowledge of the field should be able to understand the case study and implement it.
The case study should tell a story of how someone would use the invention.
Describe in detail every step of the process of transforming the inputs to the outputs. Create user stories in the context of the case study. If end users are involved, describe their interactions with the system. Also, describe the interactions between the system and other systems as part of each step.
Describe in detail how the novelty is exhibited in the case study. Describe how this is different from previous approaches. Articlate the value or benefits of the novelty in this context.
Include relevant data, source code, and output. Create real world examples to demonstrate the invention.
Constraints; Define the constraints in the context of the case study. If an LLM is used, define constraints in terms of how the prompt is implemented to ensure that the LLM produces consistent and high quality outputs that are expected. If other systems are used, explain the constraints in implementation that produce high quality and consistent output.
Settings; Define any settings that would be set in the context of the case study.
Relevant AI system/processes/models with any training details in the context of the case study.
Generate seqdiag code for a sequence diagram of all the interactions between users and systems.

Please provide references from the context for each of the items above. If insights or content is generated out of your own knowledge and not the context, then specify that explicitly.

```
    $standard_instructions
    “““)
  # pseudocode_prompt = Template(”””
  # For the Novelties below, please provide pseudo-code for the
invention. Include detailed implementations of functions to explain how they are
implemented.\n
  # Novelty:
  # $novelty \n
  # Please add comments to the pseudo-code to explain the algorithms.
  # Please also add a graphviz diagram describing the flow of the code.
  # Please provide references to the codebase from the context where
applicable.
  # $standard_instructions
  # “““)
  llm_details_prompt = Template(”””
    ### Instructions:
```

1. For the Novelties below, please provide details of the LLM used to implement the invention.

2. Please provide the prompt used to generate the output.

3. Please provide examples of the outputs of the prompts used.

```
    Novelty:
    $novelty \n
    $standard_instructions
    ### Output format:
    # LLM Details
    Define the LLMs used to implement the invention.
    # Prompt
    Provide the prompt used to generate the output.
    # Examples
    Provide examples of the outputs of the prompts used.
    “““)
  datastructures_prompt = Template(”””
    For the Novelties below, please provide data structures used in the
invention.
    Novelty: $novelty
    Please provide syntactically correct Graphviz dot code for each data
structure.
    <for each data structure>
      # Data Structure
      Define the data structure.
      # Graphviz dot code
      Provide syntactically correct Graphviz dot code for the data
      structure.
    </for>
    “““)
  implementation_prompt = Template(”””
    ### Instructions:
```

1. For the invention below, please state specific implementation details related to the novelty. For example, if you are using an AI engine, please provide the details of the input and outputs to the AI engine along with details of configuration and training that constrain the AI engine to produce specific and consistent outputs.

2. For the invention below, please list all known Alternatives with comparative capabilities to the invention. Please list all the disadvantages for each of the alternatives listed.

```
    Novelty:
    $novelty \n
    $standard_instructions
    ### Output format:
    # Implementation Details
    Define the implementation details related to the novelty.
    # Alternatives
    List all known Alternatives with comparative capabilities to the
invention. Please list all the disadvantages for each of the alternatives
listed.
    “““)
  alternatives_prompt = Template(”””
    ### Instructions:
```

1. For the Novelties below, please list all known Alternatives with comparative capabilities to the invention. Please list all the disadvantages for each of the alternatives listed.

```
      Novelty: $novelty \n
      $standard_instructions
      ### Output format:
      # Alternatives
      List all known Alternatives with comparative capabilities to the
invention. Please list all the disadvantages for each of the alternatives
listed.
      “““)
  qc_output_format = ”””
    ## Output Format:
    For the gaps, please ensure the following:
      - Be specific about the corrections to be made
      - Suggest exactly how the content should be changed
      - Provide each issue as a bullet point
    for the score, please use the following criteria:
```

0 if the section does not address any of the key elements in the evaluation criteria
3 if the section addresses some of the key elements in the evaluation criteria, but misses out on 2 or more
6 if the section addresses most of the key elements in the evaluation criteria, but misses out on only 1
8 if the section addresses all the key elements in the evaluation criteria, but has minor issues like formatting, grammar, etc.
10 if the section addresses all the key elements in the evaluation criteria and has no issues

The output should be in JSON format following the JSON schema below:

```
    ‘‘‘JSONSchema
    {
        ″qc″: ″QC results for section analysis″,
        ″type″: ″object″,
        ″properties″: {
          ″gaps″: {
            ″description″: ″Markdown string containing Bullet points
of the gaps in the section that need to be addressed.″,
              ″type″: ″string″
          },
          ″score″: {
            ″description″: ″0-10 (0 if there are important changes
that need to made to this section, 10 if the section has no more changes to
be made, 8 indictaes minor changes like formatting that need to be made)″,
              ″type″: ″integer″
          }
        },
        ″required″: [″gaps″, ″score″]
    }
    ’’’
    example JSON output:
    {
      ″gaps″: ″The section does not address the key elements of the
evaluation criteria. The section is missing the problem statement and the
implementation details.″,
      ″score″: 2
    }
    IMPORTANT: DO NOT PROVIDE ANY ADDITIONAL TEXT or
ANNOTATIONS in the output. ONLY the JSON object should be provided.
  ″″″
  section_qc_prompts = {
    Sections.Summary.value: Template(f″″″
```

Please evaluate the executive summary provided below for the following:
Does the summary clearly convey the core invention and value proposition?
Does it touch on key elements like problem solved, novelty, benefits?
Is it concise yet informative—can it stand on its own?
Does it cover the category and subcategory of the novelty?
Does it use clear, non-technical language suitable for executives?
Remember that this is an executive summary and therefore should be concise and to the point without going into too much detail.

The executive summary is as follows:

```
  $content
  {qc_output_format}
“““),
Sections.Context.value: Template(f”””
```

Please evaluate the context and environment provided below for the following:
Specifies the domain and use case(s) for the invention/novelty
Differentiates where invention is used vs. potential applicability
Provides relevant context to understand invention's purpose

The context and environment is as follows:

```
  $content
  {qc_output_format}
“““),
Sections.Problem.value: Template(f”””
```

Please evaluate the problem statement provided below for the following:
Articulates specific shortcomings in prior approaches
Contrasts how invention improves on the state of the art
Demonstrates insight into the problem space and customer needs

The context and environment is as follows:

```
  $content
  {qc_output_format}
“““),
Sections.Implementation.value: Template(f”””
```

Please evaluate the introductory information provided below for the following:
Provides relevant background for core concepts used (e.g. algorithms)
Explains key building blocks at an appropriate level of detail
Sets the stage to understand implementation details

The introductory information is as follows:

```
  $content
  {qc_output_format}
“““),
Sections.WhatAndHow.value: Template(f”””
```

Please evaluate the What & How provided below for the following:
Details each processing step from input to output
Specifies data sources, formats, and models
Describes key algorithms, operations, and modules
Includes case studies demonstrating real-world usage
Includes pseudocode and flow diagrams explaining how the invention works
The pseudocode should be detailed and include comments explaining key steps
Specifies key constraints, settings and configuration details
If the content is AI related, it must include details of the prompts used.
If the content is AI related, it must include examples of the outputs of the prompts used.

The What & How is as follows:

```
  $content
  {qc_output_format}
“““),
Sections.LLMDetails.value: Template(f”””
```

##Please evaluate the LLM details provided below for the following:
Defines the LLM used to implement the invention.
Provides the prompt used to generate the output.
Provides examples of the outputs of the prompts used.

- Provides examples of the outputs of the prompts used.
“““),
Sections.DataStructures.value: Template(f”””

##Please evaluate the data structures provided below for the following:
Covers all core data structures used in implementation
Specifies fields and data types
Provides visual representations (e.g. schema diagrams)
Explains how data structures are used in the invention

The data structures are as follows:

```
    $content
  {qc_output_format}
      “““),
Sections.ImplementationDetails.value: Template(f”””
```

##Please evaluate the Introduction to implementation details provided below for the following:
Provides implementation specifics beyond high-level What & How
Details key configuration settings and rationale
Covers training details for ML/AI components
Discusses tradeoffs and rationale for implementation choices

The implementation details are as follows:

```
    $content
  {qc_output_format}
      “““),
Sections.Alternatives.value: Template(f”””
```

##Please evaluate the Alternatives provided below for the following:
Describes prior art and alternative approaches
Demonstrates awareness of competitive landscape
Articulates specific disadvantages of each alternative a
Highlights invention's advantages over alternatives

The alternatives section is as follows:

```
      $content
    {qc_output_format}
        “““)
}
def get_qc_prompt_template_for_section(section):
  return section_qc_prompts[section.name]
prompts_map = {
  Sections.Summary.value: summary_prompt,
  Sections.Context.value: context_prompt,
  Sections.Problem.value: problem_prompt,
  Sections.Implementation.value: implementation_prompt,
  Sections.WhatAndHow.value: what_and_how_prompt,
  Sections.LLMDetails.value: llm_details_prompt,
  # Sections.Pseudocode.value: pseudocode_prompt,
  Sections.DataStructures.value: datastructures_prompt,
  Sections.ImplementationDetails.value: implementation_prompt,
  Sections.Alternatives.value: alternatives_prompt
}
def get_prompt_for_section(section):
  if section.name in prompts_map:
    return prompts_map[section.name]
  return None
```

Once the input data 104 received by the data processing module 110 is processed and structured, using, for example, prompts, the invention disclosure generator 112 guides and constrains the AI engine 114 to extract the one or more novel ideas underlying the invention for which the invention disclosure is being generated. The AI engine 114 involves advanced computational techniques that help identify unique aspects of the invention, distinguishing the invention from existing solutions and innovations. In at least one embodiment, the AI engine 114 is ChatGPT, owned by OpenAI, has its headquarters in San Francisco, California, United States.

The AI engine 114 utilizes Natural Language Processing (NLP) and Machine Learning (ML) algorithms to analyze the input data 104 for extracting the one or more novel ideas.

NLP enables the AI engine 114 to interpret and understand technical documentation, research papers, patent literature, and other textual sources by breaking down complex sentences, recognizing key concepts, and identifying relationships between different elements of the invention. This allows the AI engine 114 to discern unique aspects of the input data 104 and differentiate from existing technologies. The ML algorithms detect patterns and classify innovations based on their distinguishing features. The NLP and ML algorithms help recognize novel contributions by comparing the input data 104 with prior knowledge, identifying gaps, and identifying areas of advancement that make the invention unique.

The NLP and ML algorithms analyze text, source code, and diagrams to identify unique concepts, technical advancements, and non-obvious improvements over existing technologies. The AI engine 114 can assess how an invention builds upon previous work, finding gaps that the new idea fills. By understanding these differentiators, the AI engine 114 ensures that the extracted one or more novel ideas align with the technical aspect. The AI engine 114 can extract essential concepts, recognize industry-specific terminologies, and establish relationships between different components of the invention. This understanding enables the AI engine 114 to categorize the invention within relevant technological fields, ensuring that the novel idea is appropriately framed within the context of existing developments.

Once the AI engine 114 processes at least the documents and the source code, the AI engine 114 automatically transforms the information into an organized coherent format that, for example, highlights key technical advancements and distinguishes conventional features. This structured output can be used for patent drafting, research documentation, and strategic decision-making in technology development.

In operation 206, the AI engine 114 utilizes one or more embedding models 118 to generate full context from the project documentation. The one or more embedding models 118 are configured to generate full context from the project documentation. The one or more embedding models 118 convert the data (such as text, images, and audio) within the project documentation into meaningful numbers to find patterns or connections. The full context is numerical representations of text data that capture semantic meaning, relationships, and contextual nuances within the project documentation. The full context enables the AI engine 114 to understand and interpret technical content effectively, improving the ability of the AI engine 114 to generate insights, recommendations, and structured outputs. By generating full context, the one or more embedding models 118 transforms unstructured project documentation into an analyzable and machine-readable format.

The full context allows the AI engine 114 to understand the intent and context of a query, leading to a precise and insightful response. For example, when a query for a particular function is asked to the one or more embedding models 118, the one or more embedding models 118 retrieve relevant full context and provide explanatory insights from the documentation project associated with the query. This ensures that the retrieved information is technically accurate.

Receiving relevant source code snippets using the RAG 116 process and the full context by the one or more embedding models 118 comprises analyzing contextual similarities using a vectorized method. When a query is made, the query, the stored one or more relevant source code snippets, and the full context are converted into numerical representations called vectors. The vectors are generated using advanced NLP and ML algorithms that capture the semantic meaning, functional purpose, and contextual relevance of the code. The vectors allow the AI engine 114 to understand the relationships between different pieces of code to identify relevancy based on structure, functionality, and context.

Moreover, the RAG 116 process uses cosine similarity, the RAG 116 process ranks the one or more relevant source code snippets based on how closely they match the contextual meaning of the query. This allows the RAG 116 process to retrieve code that is syntactically similar and functionally relevant to the given task.

In operation 206, the AI engine 114 utilizes a retrieval-augmented generation process 116 and an embedding model and embeddings based on the determined context of the documents to identify one or more source code snippets of the source code that are relevant to at least a portion of the invention and retrieve the identified one or more code snippets from a codebase stored in a repository. RAG 116 process is an AI-driven technique that combines the capabilities of retrieving relevant information from a large dataset and generating context-aware content based on retrieved information. The RAG 116 process is configured to retrieve relevant information from the source code stored in a source code repository and generate meaningful insights based on the retrieved data. Specifically, the RAG 116 process retrieves one or more relevant source code snippets from the source code.

The source code repository is a centralized storage system where developers maintain and manage code files related to different projects, software applications, and technology solutions. The source code repository contains a plurality of code lines that span various programming languages, frameworks, and functionalities. When analyzing or generating content, the RAG 116 process searches the source code repository to identify and extract the one or more relevant source code snippets from the source code that align with a given query, project requirement, or technical concept. This retrieval process involves advanced search techniques, such as keyword matching, syntax analysis, and pattern recognition, to ensure that the retrieved source code snippet is highly relevant and useful in the given context.

In at least one embodiment, the RAG 116 process leverages indexing and search mechanisms that organize the source code repository into a structured format, making easier for the RAG 116 process to locate specific code components to enhance the accuracy of retrieval, ensuring that the RAG 116 process fetches one or more relevant source code snippets which are relevant and functionally compatible with the project being analyzed.

In operation 210, the AI engine 114 transforms the documents and source code snippets into an invention disclosure utilizing the generated context of the documents and the identified one or more source code snippets. In at least one embodiment, the AI engine 114 processes the retrieved one or more relevant source code snippets and the generated full context to identify the one or more novel ideas via a guided and constrained information to invention disclosure transformer 120.

The guided and constrained information to invention disclosure transformer 120 analyzes retrieved one or more relevant source code snippets and full context to identify the one or more novel ideas within the source code. The guided and constrained information to invention disclosure transformer 120 processes the retrieved one or more relevant source code snippets and full context to ensure that the retrieved one or more relevant source code snippets and full context are ready for analysis. This includes standardizing the format of the source code, normalizing variable names, and removing redundant or repetitive code structures. The guided and constrained information to invention disclosure transformer 120 tokenizes the source code, breaking down the source code and full context into smaller components such as functions, classes, and logical expressions.

Once the source code is prepared for analysis, the guided and constrained information to invention disclosure transformer 120 compares the retrieved snippets against existing codebases. In at least one embodiment, the guided and constrained information to invention disclosure transformer 120 uses similarity metrics, pattern recognition algorithms, and deep learning models to evaluate how closely the retrieved snippets resemble known implementations. If the retrieved code contains structures, algorithms, or functionalities that are not found in existing databases, the guided and constrained information to invention disclosure transformer 120 flags them as potentially novel.

The full context enables the guided and constrained information to invention disclosure transformer 120 to recognize cases where the user has introduced a groundbreaking feature, even if the underlying syntax resembles existing implementations. This semantic understanding helps distinguish between incremental improvements and novel ideas, ensuring that the invention disclosure generator 112 accurately identifies meaningful innovations.

Moreover, the guided and constrained information to invention disclosure transformer 120 compares the retrieved one or more relevant source code snippets against patent databases and prior art repositories. The guided and constrained information to invention disclosure transformer 120 cross-references the retrieved code with existing patents, published research papers, and technical documentation to determine whether the identified novelty is new or an improvement upon previous work. The guided and constrained information to invention disclosure transformer 120 utilizes a corpus of patent documents to enhance the accuracy of novelty detection.

The one or more embedding models 118 capture semantic meaning, relationships, and contextual relevance, allowing the guided and constrained information to invention disclosure transformer 120 to understand and analyze technical content effectively. By training the guided and constrained information to invention disclosure transformer 120 on patent documents, which contain detailed descriptions of prior inventions, technical methodologies, and claims, the one or more embedding models 118 gain an in-depth understanding of existing innovations across various domains. Allowing the guided and constrained information to invention disclosure transformer 120 to compare retrieved one or more relevant source code snippets and full context against the structured knowledge base of patented technologies, ensuring that potential novel contributions are accurately distinguished from existing implementations. Through this training, the guided and constrained information to invention disclosure transformer 120 becomes adept at recognizing patterns, terminologies, and unique attributes that define patented ideas, allowing for a more refined analysis of whether the retrieved code snippet and the full context represent the innovative concept.

When the guided and constrained information to invention disclosure transformer 120 processes retrieved one or more relevant source code snippets and the generated full context, it leverages the trained one or more embedding models 118 to assess their similarity to patent documents. The guided and constrained information to invention disclosure transformer 120 uses semantic analysis to identify underlying concepts and technical advancements present in the code.

In operation 212, the identified one or more novel ideas are reviewed by the engineer, via the user interface 106, to identify whether the identified one or more novel ideas align with the input data 104.

When the one or more novel ideas are generated, they are examined by the engineer to determine their relevance, feasibility, and alignment with the input data 104 via the user interface 106. Typically, the engineer begins by breaking down each novel idea from the generated one or more novel ideas to analyze its relevance and alignment with the provided input data 104. For example, if the input data 104 specifies that a certain product must operate within a specific temperature range or use particular materials, the engineer must verify whether the novel idea adheres to these constraints. If an idea does not fit within these parameters, it may need further refinement or re-evaluation.

The review process also involves identifying any potential conflicts or inconsistencies between the one or more novel ideas and the input data 104. If the novel idea from the one or more novel ideas contradicts a concept established in the input data 104, then the engineer prompts the AI-guided invention disclosure generation system 100 to re-generate the invention disclosure 102. The user interface 106 enables the engineer to view the generated one or more novel ideas. The user can modify or suggest any changes to the generated one or more novel ideas.

In operation 214, the invention disclosure generator 112 generates a patentability score for the one or more novel ideas by utilizing a patentability assessment module 122. The patentability score is a metric that provides an objective assessment of how likely the one or more novel ideas are patentable and defensible.

The patentability assessment module 122 utilizes historical patent data and predefined innovation categories for providing patentability scores to the one or more novel ideas. The patentability assessment module 122 retrieves historical patent data from global patent databases, research papers, and technical literature. This historical patent data serves as a reference point to determine whether an idea is novel or if it resembles existing patents. The patentability assessment module 122 processes vast amounts of textual and structured data, extracting relevant information such as technical specifications, claims, citations, and classifications of previously granted patents. By analyzing the historical patent data to identify patterns and trends in innovation.

Once the historical patent data has been gathered, the patentability assessment module 122 employs the ML models trained on patent data for scoring, thereby analyzing similarity between the one or more novel ideas and existing patents. The patentability assessment module 122 breaks down the one or more novel ideas into key components, including its functional aspects, structural elements, and intended applications. These key components are then compared against patents with similar attributes. This allows the patentability assessment module 122 to measure how closely related the one or more novel ideas are to existing patents.

The patentability assessment module 122 classifies the novel idea into predefined innovation categories. The innovation categories represent different fields of technology, such as artificial intelligence, biotechnology, mechanical engineering, telecommunications, and software development. Classifying the innovation categories helps in refining the patentability score by contextualizing the novel idea within its specific domain. Below are the exemplary patentability scores:

‘A score of 0 means that the idea is not patentable.’
‘A score of 6 means that there is prior art on the subject.’
‘A score of 10 means that there is a very objective probability of patent
ability.’

In the above example, a greater patentability score may indicate a strong case for filing a patent application on the proposed invention. On the other hand, a lower patentability score may suggest that the idea or invention is not patentable.

In at least one embodiment, the patentability assessment module 122 assigns weights to various factors that determine or influence patentability. These factors may include originality of the concept, technical complexity, potential impact on industry practices, and the legal viability of obtaining the invention disclosure 102. The patentability score typically ranges from 0 to 10, with higher scores indicating a stronger likelihood of obtaining a patent on the invention disclosure 102.

Moreover, the patentability assessment module 122 utilizes a probabilistic or statistical model that uses a scoring algorithm, wherein a score of 0 indicates non-patentability and a score of 10 indicates a maximum probability of patentability. The scoring algorithm analyzes various factors such as novelty, technical complexity, similarity to existing patents, and legal eligibility. The scoring algorithm is represented on a scale from 0 to 10, where 0 indicates that the idea is highly unlikely to be patentable, while a score of 10 signifies the maximum probability of securing a patent. The scoring algorithm processes historical patent data and predefined innovation categories to assess the uniqueness and significance of the idea.

The probabilistic model generates score using the scoring algorithm, which scores each novel idea from the one or more novel ideas, and each score reflects a confidence level rather than a definitive determination. For example, a score of 8 suggests that the idea has a strong chance of being patentable but may require further refinement or legal scrutiny. A lower score, such as 2, indicates that the idea may be too similar to existing patents or lack sufficient technical innovation.

In operation 216, the invention disclosure 102 is generated via the AI engine 114, including a detailed description associated with the reviewed one or more novel ideas.

Once the patentability score is assigned to the one or more novel ideas, the AI engine 114 is configured to prepare the invention disclosure 102. Typically, generating the invention disclosure 102 involves the one or novel ideas reviewed by the engineer. The one or more novel ideas form the patent application that differentiate it from existing technologies. The invention disclosure 102 incorporates the one or more relevant source code snippets and the full context that demonstrates the technical implementation of the invention. The one or more relevant source code snippets are selected to illustrate the unique aspects of the invention while avoiding excessive technical detail. Each code snippet is accompanied by explanations to describe its functionality.

The full context includes diagrams, flowcharts, system architecture descriptions, and technical specifications that illustrate how the invention operates within its intended environment.

To ensure clarity and completeness, the invention disclosure 102 follows a standardized format. In at least one embodiment, the structured invention disclosure 102 serves as a resource for conducting prior art analysis and competitive research.

Moreover, reviewing the identified one or more novel ideas by the engineer allows for updating and/or modifying the generated invention disclosure 102. When the engineer reviews novel ideas, he/she assesses the technical details and feasibility of the invention. Such review helps in identifying gaps, inconsistencies, or areas where the invention disclosure 102 can be strengthened. If an idea lacks clarity or does not fully explain its functionality, the engineer may provide feedback to the invention disclosure generator 112 that may lead to prompting the AI engine 114 to refine the description for making the description precise and comprehensive.

Furthermore, the review process helps in identifying and integrating additional features that may enhance the invention's scope. Sometimes, during the review, the engineer discovers alternative embodiments, variations, or technical improvements that were not initially considered. Incorporating these insights into the invention disclosure 102 can strengthen the patent application by covering a broader range.

The invention disclosure generation system 100 further includes a database 124 that stores the generated invention disclosure 102.

The database 124 acts as a centralized repository, ensuring that every piece of relevant information related to the invention disclosure 102 is securely stored, organized, and readily accessible. The processed data within the database 124 includes the identified novel ideas, retrieved source code snippets, full context, and patentability scores. By maintaining this information in a structured format, the database 124 allows for efficient data retrieval and analysis.

The database 124 stores the generated invention disclosure 102 provided by the engineer corresponding to the input data 104, including technical documentation, research papers, innovation records, and expert analyses. The generated invention disclosure 102 is processed and stored in a structured format within the database 124. This structured storage allows for seamless access, comparison, and refinement.

In at least one embodiment, the database 124 stores retrieved one or more relevant source code snippets, patentability scores. In at least another embodiment, the database 124 utilizes indexing, categorization, and tagging mechanisms that enable efficient filtering and organization of the stored invention disclosure 102.

Below is the pseudo-code for generating the invention disclosure 102.

```
  # Step 1: Generate Novel Ideas
  function generateNovelIdeas(documentation, sourceCode, innova tionMap):
  # Use RAG 116 process embedding to analyze source code and documentat
  ion
  relevantCodeSnippets = RAGEmbedding(sourceCode)
  # Generate novel ideas based on documentation and innovat
  ion map
  novelIdeas = analyzeDocumentation(documentation, innovati onMap)
  # Combine code snippets with novel ideas
  combinedIdeas = combine(relevantCodeSnippets, novelIdeas) return
combinedIdeas
  # Step 2: Create Full Invention disclosure
  function createPatentDisclosure(novelIdeas, documentation, sourceCode,
innovationMap):
  # Edit and finalize the list of novel ideas editedNovelIdeas =
editNovelIdeas(novelIdeas)
  # Generate detailed descriptions for each novelty detailedDescriptions
= generateDescriptions(editedNovelId
  eas)
  # Generate patentability scores for each novelty patentabilityScores =
calculatePatentabilityScores(edited
  NovelIdeas)
  # Create full disclosure document
  fullDisclosure = formatDisclosure(detailedDescriptions, p
  atentabilityScores) return fullDisclosure
  # Main algorithm
  documentation = getInputDocumentation( ) sourceCode = getSourceCode( )
innovationMap = getInnovationMap( )
  novelIdeas = generateNovelIdeas(documentation, sourceCode, in
novationMap)
  fullDisclosure = createPatentDisclosure(novelIdeas, documenta tion,
sourceCode, innovationMap) outputDisclosure(fullDisclosure)
```

The RAGEembedding function corresponds to the use of RAG 116 process embedding for source code analysis. The analyzedocumentation function involves the analysis of the input documentation against the innovation map to identify potential novelties. The calculatePatentabilityScores function generates the patentability score for each identified novelty.

Moreover, encrypting invention disclosure 102 within the database 124 ensures the security and confidentiality of the identified novel ideas, retrieved one or more relevant source code snippets, full context, and patentability scores. The encryption is a process that converts data associated with the invention disclosure 102 into an unreadable format using cryptographic algorithms, making it accessible only to authorized users with the appropriate decryption keys such as the engineer. This prevents unauthorized access, theft, or tampering with valuable innovation-related information. In at least one embodiment, the Advanced Encryption Standard (AES) and RSA encryption are used to secure data within the database 124. If an external entity attempts to breach the database 124, the encrypted data remains protected.

In at least one embodiment, generating a user-interpretable report summarizing identified novel concepts, retrieved one or more relevant code snippets, full context, and the patentability score. The user-interpretable report serves as a comprehensive summary of the innovation, distilling essential details into a clear and concise format that can be easily reviewed by engineers, inventors, patent attorneys, and the like. By organizing the extracted novel concepts, the user-interpretable report highlights the key aspects of the invention that differentiate it from existing technologies. The inclusion of retrieved one or more relevant code snippets provides concrete technical references, demonstrating the functional implementation of the innovation. The full context enhances understanding by connecting the novel concepts with relevant documentation, making it easier to interpret the broader significance of the invention. The patentability score offers a quantitative measure of uniqueness. The user-interpretable report is designed to be user-friendly, incorporating visual elements such as charts, tables, and structured sections that improve readability and comprehension.

In at least one embodiment, the AI-guided invention disclosure generation system 100 can be utilized in educational software development companies and individuals who are involved in creating educational software, such as learning management systems (LMS), educational games, or adaptive learning tools. The AI-guided invention disclosure generation system 100 would benefit from efficiently documenting and protecting its intellectual property.

In another embodiment, the AI-guided invention disclosure generation system 100 can be utilized in research institutions as they develop new educational technologies or methodologies. In yet another embodiment, the AI-guided invention disclosure generation system 100 can be utilized in corporate training and professional development programs that utilize proprietary technology that assist in protecting assets through patents. In yet another embodiment, the AI-guided invention disclosure generation system 100 can be utilized in startups in the educational technology space to establish their intellectual property portfolio quickly and efficiently.

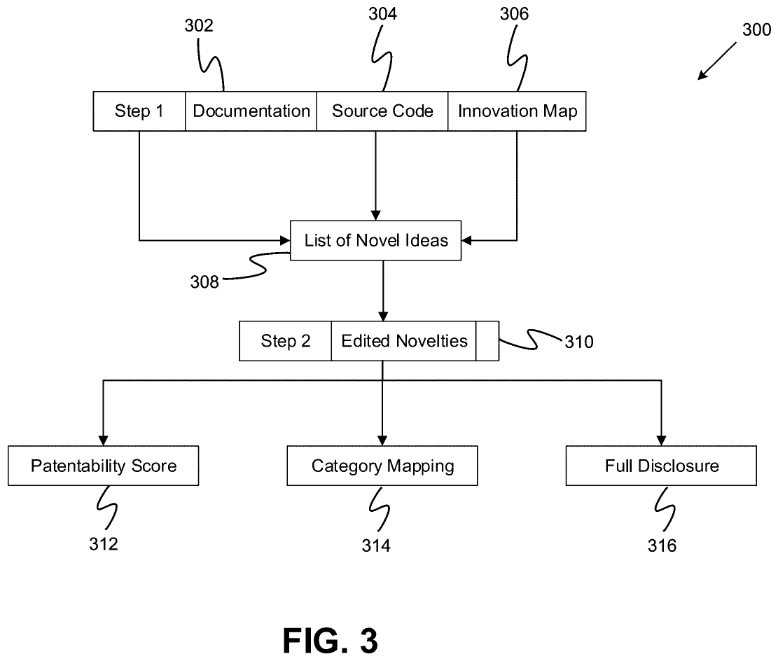

FIG. 3 depicts a data structure 300 used to organize the data utilized by the AI-guided invention disclosure generation system of FIG. 1.

As discussed in conjunction with FIGS. 1 and 2, the invention disclosure generation system 100 includes two step approach for identifying novel ideas and generation of invention disclosures. Step 1 includes providing three primary input data that contribute to the identification of novel ideas. A data structure 302 stores information related to project documentation, which includes technical documents, research papers, or project-related reports that describe the invention. Another data structure 304 includes data related to the source code, which may include any software or algorithmic implementation associated with the invention. Further, data structure 306 includes data related to an innovation map, which is a structured representation of the invention highlighting uniqueness, components, and technological significance related to the invention. These data stored in the three data structures for documentation, source code, and innovation map is utilized to generate one or more novel ideas, which are stored in data structure 308.

Further, before step 2 begins, the novel ideas are reviewed by the user who is working on the invention idea. The user may be an engineer who may edit the novel ideas during review. These edited novelties or novel ideas are stored in data structure 310. At step 2, the edited novelties stored in 310 are utilized by the patentability assessment module 122 for generation of patentability scores. The generated patentability scores are stored in data structure 312. The patentability score is a scoring system that evaluates the likelihood of the novel idea being patentable based on historical data, prior patents, and predefined innovation categories.

The one or more reviewed novel ideas are mapped against one or more categories (a.k.a. innovation categories). Such mapped novel ideas are stored in data structure 314. Finally, the reviewed novel ideas along with mapped category and patentability scores are provided to the AI engine for generation of full disclosure or invention disclosure 102. The generated full disclosure is then stored in data structure 316. The full disclosure is a structured invention disclosure that is generated, incorporating the edited novel ideas along with supporting documentation and analysis.

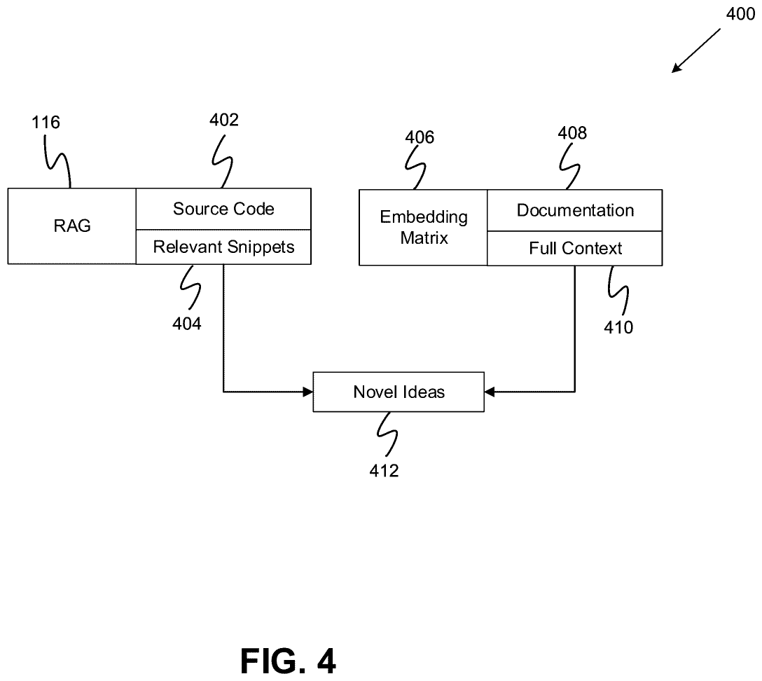

FIG. 4 depicts another data structure used to organize the data utilized by the AI-guided invention disclosure generation system of FIG. 1.

As shown, the RAG 116 process retrieves source code from a data structure 402 and processed the source code to retrieve relevant code snippets. The retrieved relevant code snippets are stored in data structure 404 and used by the AI engine 114 for identifying novel ideas. The retrieved relevant snippets provide technical depth to support novelty assessment.

Further, as shown in FIG. 4, an embedding matrix 406 represents a structured numerical encoding of textual or contextual information.

The embedding matrix 406 utilizes data structure 408 including project documentation and data structure 410 storing full context, which is generated by the embedding matrix 406 based on the received project documentation. The embedding matrix 406 may be interchangeably stated as one or more embedding models 118. The project documentation or documentation stored in data structure 408 provides descriptive explanations, research notes, or design specifications that add depth to the relevant snippets 404. The full context generated from the documentation ensures that the relevant code snippets are not analyzed in isolation but within the broader scope of the project or invention.

Finally, the generated full context and relevant snippets of code are used to generate one or more novel ideas, which are stored in data structure 412. As shown here, the combined analysis using the RAG 116 process and embedding matrix 406 leads to the identification of unique and innovative novel ideas or concepts.

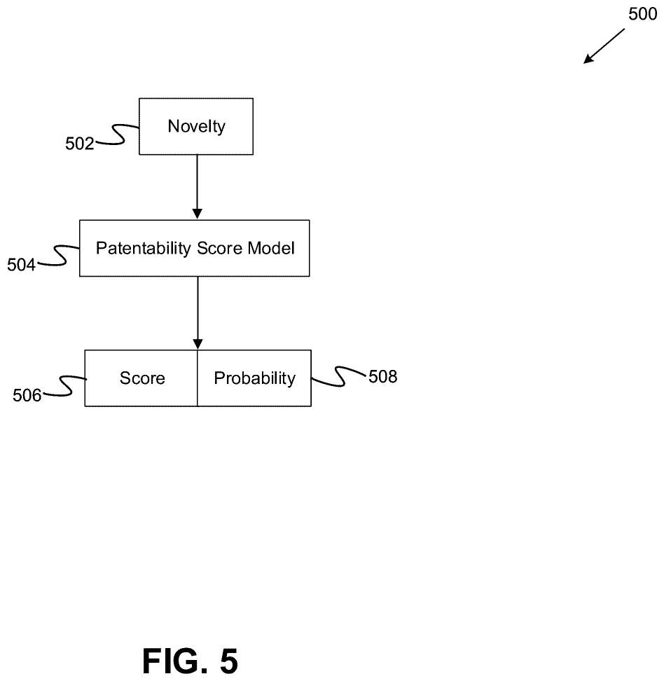

FIG. 5 depicts a data structure 500 used to organize the data utilized by the AI-guided invention disclosure generation system of FIG. 1 for evaluating the patentability of one or more reviewed novel ideas.

The generated novel ideas or novelty is stored in a data structure 502. The novelty is fed into a patentability score model 504, which serves as an analytical tool for evaluating the patentability of novel ideas or novelty. The patentability score model 504 utilizes historical patent data, legal frameworks, machine learning algorithms, and predefined innovation categories to assess how unique and patent-eligible the idea is. The patentability score model 504 ensures that the evaluation is data-driven, reducing subjectivity in determining patent feasibility.

The patentability score model 504 generates a score and a probability, which are stored in data structures 506 and 508 respectively. The score is a numerical value indicating the overall patentability potential of the novel idea, whereas probability is a statistical measure reflecting the likelihood of the novel idea being successfully granted the patent. The probability may be based on past patent approvals, similar innovations, and legal considerations.

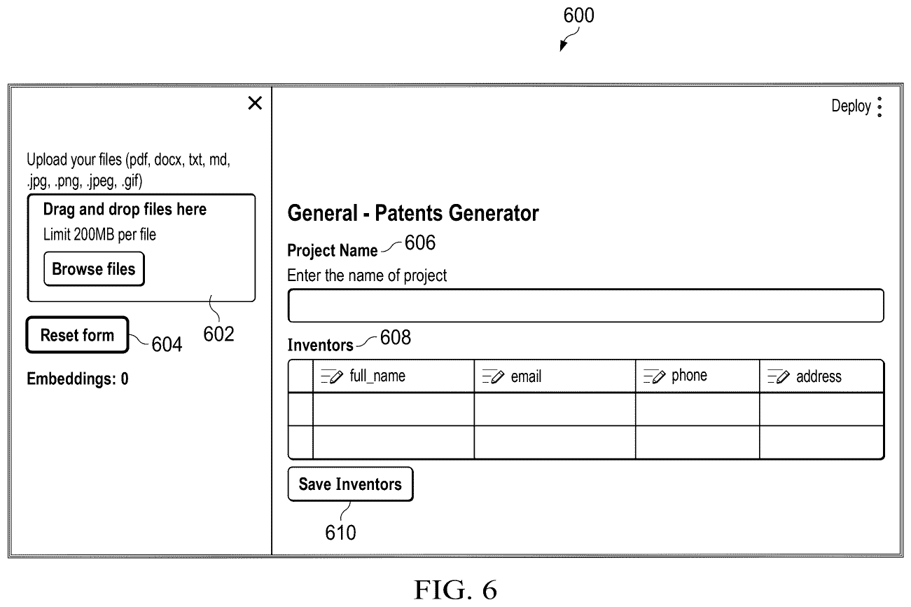

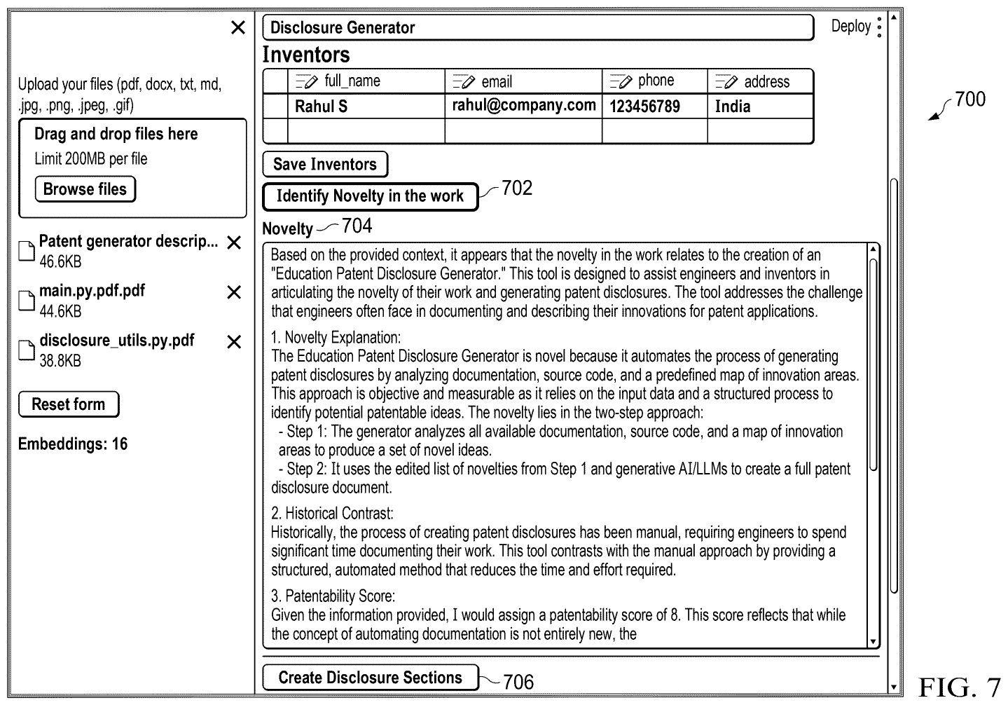

FIGS. 6 and 7 are exemplary user interfaces 600 and 700 for managing and generating the invention disclosure 102.

Referring to FIG. 6, as shown, a file upload section 602 allows the user to upload various document types, including PDF, DOCX, TXT, MD, JPEG, PNG, GIF, indicating support for both text-based and image-based files. The user can either ‘drag and drop’ files into the upload area or use the ‘browse files’ button to select files to upload the file on the file upload section 602. The limit of files to be uploaded is 200 MB per file. A “reset form” tab 604 clears the uploaded files and resets the input fields. The user interface 600 also displays the embeddings section to process and analyze uploaded data and identify the embeddings within the uploaded files.

A “Project Name” section 606 allows the users to enter the name of the project associated with the invention disclosure 102. The “Project Name” section 606 ensures that every uploaded document is linked to a specific project for better organization and tracking.

An “Inventors” section 608 contains a table with fields for entering details about the inventors associated with the project. The table includes columns for: full name, email, phone number, and address. The fields ensure that all necessary contact details of inventors are collected for patent filings and documentation. A “Save Inventors” tab 608 saves the entered inventor details into the project. The “Save Inventors” tab 608 ensures that multiple inventors can be recorded and linked to the project.

Referring to FIG. 7, as shown, the user uploads three files through the file upload section 602 ‘patent generator description.pdf’ (46.6 KB), ‘main.py.pdf’ (44.6 KB), and ‘disclosure_utils.py.pdf’ (38.8 KB). The uploaded files contain documentation, source code, or scripts related to patent generation. Herein, the user interface 700 displays the 16 embeddings section to process and analyze uploaded data and identify the embeddings within the uploaded files.

The user entered the details in the project name section 606. Here, the user is “Rahul S” with an email (rahul@company.com), phone number (123456789), and location (US). The save “Inventors” tab 608 allows the user to save inventor details. Once the user clicks on an identify novelty in the work tab 702, it analyzes the uploaded documents, extracts important features, and presents novelty insights. A novelty section 704 displays the novelty based on the upload data. The novelty section 704 displays the analyzed documentation, source code, and a structured innovation map to identify novel ideas. The AI engine 114 is used to generate the invention disclosure 102. The AI engine 114 assigns a patentability score on a scale of 1-10 to the invention set forth in invention disclosure 102. A create disclosure tab 706 generates structured sections for the invention disclosure 102 based on the identified novel ideas. The invention disclosure generator 112 provides the invention disclosure 102

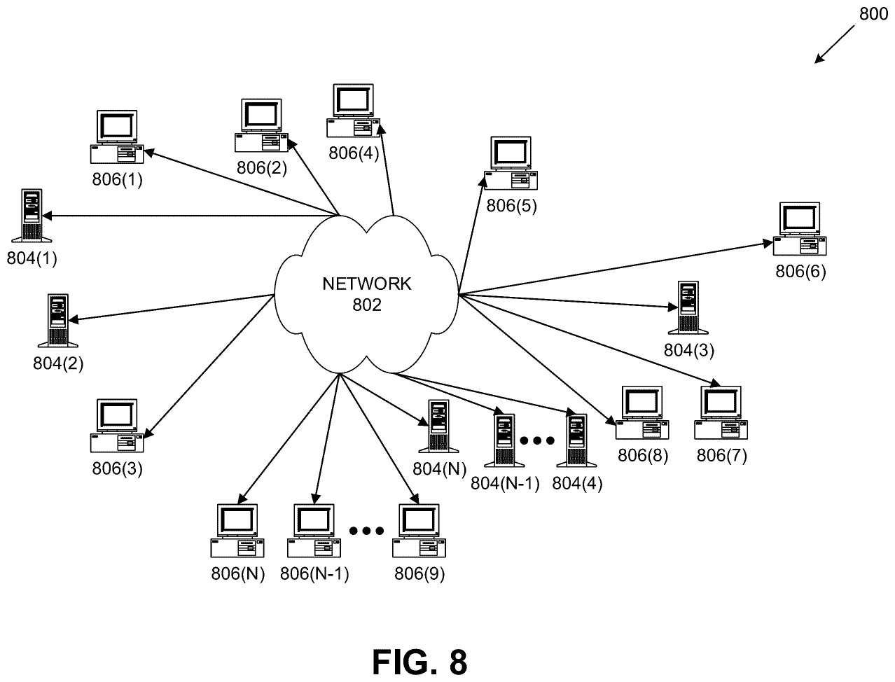

FIG. 8 is a block diagram illustrating a network environment in which an AI-guided invention disclosure generation system 100 and an AI-guided invention disclosure generation process 200 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing TI or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the AI-guided invention disclosure generation system 100 and AI-guided invention disclosure generation process 200. The type of computer system that can be specially programmed to implement and utilize the AI-guided invention disclosure generation system 100 and AI-guided invention disclosure generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-guided invention disclosure generation system 100 and AI-guided invention disclosure generation process 200 can be implemented using code stored in a tangible, non-transient computer readable medium and executed by one or more processors. In at least one embodiment, the AI-guided invention disclosure generation system 100 and AI-guided invention disclosure generation process 200 can be implemented completely in hardware using, for example, logic circuits and other circuits including field programmable gate arrays.

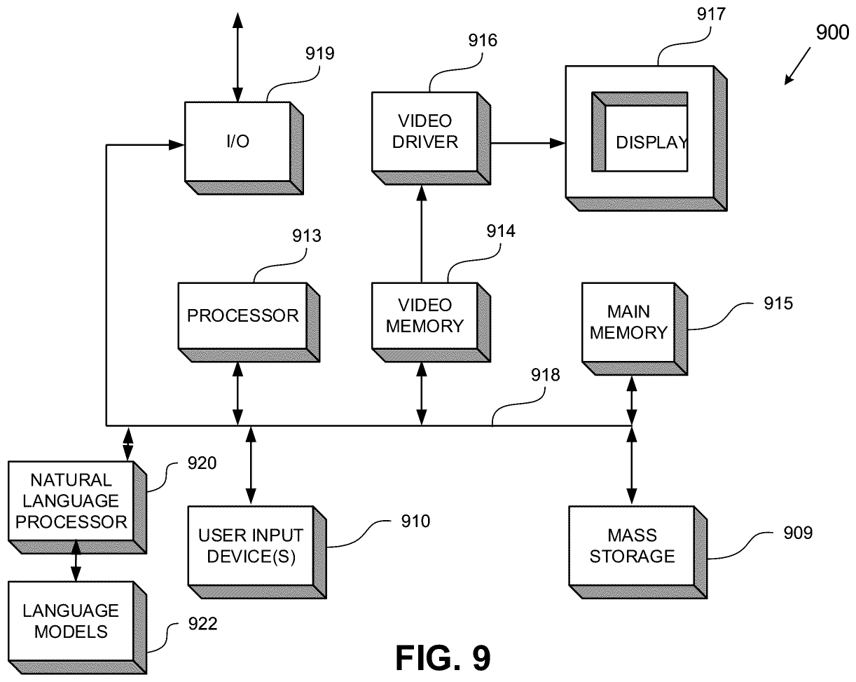

Embodiments of the AI-guided invention disclosure generation system 100 and AI-guided invention disclosure generation process 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to remote or local server computer systems via a telephone link or to the Internet via an ISP. I/O device(s) 919 may also include a network interface device to provide a direct connection to remote or local server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The AI-guided invention disclosure generation system 100 and AI-guided invention disclosure generation process 200 may be implemented in any type of computer system or programming or processing environment. It is contemplated that the AI-guided invention disclosure generation system 100 and AI-guided invention disclosure generation process 200 might be run on a stand-alone computer system, such as the one described above. The AI-guided invention disclosure generation system 100 and AI-guided invention disclosure generation process 200 might also be run from a server computer systems system that can be accessed by a plurality of client computer systems interconnected over an intranet network. Finally, the AI-guided invention disclosure generation system 100 and AI-guided invention disclosure generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for transforming input data and source code into an invention disclosure, the method comprising:
receiving an input data via a user interface of an automated invention disclosure generation platform, wherein the input data includes documents having information associated with an invention;
executing code using one or more processors of a computer system to cause the computer system to perform operations comprising:
integrating source code analysis to transform the input data and source code into an invention disclosure, wherein the integrating comprises:
guiding and constraining an artificial intelligence (AI) engine utilizing multiple prompts to analyze the documents and the source code to generate an invention disclosure, wherein guiding and constraining 12 the AI engine comprises:
determining a context of documents included in the input data using one or more embedding models;
determining issues with conventional technology;
identifying invention systems and processes;
utilizing retrieval-augmented generation (RAG) and an embedding model and embeddings based on the determined context of the documents to:
identify one or more source code snippets of the source code that are relevant to at least a portion of the invention; and
retrieve the identified one or more code snippets from a codebase stored in a repository; and
transforming the documents and source code snippets into an invention disclosure utilizing the generated context of the documents and the identified one or more source code snippets.

2. The method of claim 1 further comprising:
reviewing the invention disclosure to identify whether the identified one or more novel ideas align with the input data and the source code; and
generating patentability scores, via a patentability assessment module, for the one or more novel ideas based on historical patent data and predefined innovation categories.

3. The method of claim 2 wherein reviewing the identified one or more novel ideas by the user allows for updating and/or modifying the generated novel ideas for generation of the invention disclosure.

4. The method of claim 1 further comprising:
preprocessing the input data by normalizing, tokenizing, and structuring the input data; and
further guiding and constraining the AI engine to utilize the preprocessed input data with the AI engine to assist in generating the invention disclosure.

5. The method of claim 1 wherein retrieving one or more relevant source code snippets using the RAG 116 process further comprises:
converting the received source code into vector embeddings using natural language processing techniques; and
guiding and constraining an Artificial Intelligence (AI) engine further to:
analyze contextual similarities between the vector embeddings and documentation embeddings, wherein the documentation embeddings are created based on project documentation using one or more embedding models; and
identifying relevant source code snippets based on contextual relevance of the vector embeddings to the project documentation and other input data.

6. The method of claim 1 further comprising
assigning a probabilistic patentability score using a scoring algorithm, wherein a score of 0 indicates non-patentability and a score of 10 indicates a maximum probability of patentability.

7. The method of claim 1 wherein guiding and constraining an Artificial Intelligence (AI) engine further comprises to perform comparative analysis of the generated detailed description against a historical patent data to demonstrate uniqueness of the generated invention disclosure.

8. The method of claim 1, further comprising generating a user-interpretable report summarizing identified one or more novel ideas, retrieved one or more relevant code snippets, full context, and the patentability score.

9. The method of claim 1 wherein the input data includes project documentation, source code, and innovation map.

10. A system for transforming input data and source code into an invention disclosure, the system comprising:
one or more processors of a computer system; and
a memory, coupled to the one or more processors, storing code that when executed by the computer system causes the computer system to perform operations comprising:
receiving an input data via a user interface of an automated invention disclosure generation platform, wherein the input data includes documents having information associated with an invention;
executing code using one or more processors of a computer system to cause the computer system to perform operations comprising:
integrating source code and document analysis to transform the input data and source code into an invention disclosure, wherein the integrating comprises:
guiding and constraining an artificial intelligence (AI) engine utilizing multiple prompts to analyze the documents and the source code to generate an invention disclosure, wherein guiding and constraining the AI engine comprises:
determining a context of documents included in the input data using one or more embedding models;
determining issues with conventional technology;
identifying invention systems and processes;
utilizing retrieval-augmented generation (RAG) and an embedding model and embeddings based on the determined context of the documents to:
identify one or more source code snippets of the source code that are relevant to at least a portion of the invention; and
retrieve the identified one or more code snippets from a codebase stored in a repository; and
transforming the documents and source code snippets into an invention disclosure utilizing the generated context of the documents and the identified one or more source code snippets.

11. The system of claim 10 wherein execution of the code by the computer system causes the computer system to perform operations further comprising:
reviewing the invention disclosure to identify whether the identified one or more novel ideas align with the input data and the source code; and
generating patentability scores, via a patentability assessment module, for the one or more novel ideas based on historical patent data and predefined innovation categories.

12. The method of claim 11 wherein reviewing the identified one or more novel ideas by the user allows for updating and/or modifying the generated novel ideas for generation of the invention disclosure.

13. The system of claim 10 further comprising:
preprocessing the input data by normalizing, tokenizing, and structuring the input data; and
wherein the guiding and constraining an Artificial Intelligence (AI) engine further comprises sharing the preprocessed input data with the AI engine to assist in generating the invention disclosure.

14. The system of claim 10 wherein retrieving one or more relevant source code snippets using the RAG 116 process module further comprises:
converting the received source code into vector embeddings using natural language processing (NLP) techniques;
guiding and constraining an Artificial Intelligence (AI) engine further to:
analyze contextual similarities between the vector embeddings and documentation embeddings, wherein the documentation embeddings are created based on project documentation using one or more embedding models; and
identifying relevant source code snippets based on contextual relevance of the vector embeddings to the project documentation and other input data.

15. The system of claim 10 wherein execution of the code by the computer system causes the computer system to perform operations further comprising:
assigning a probabilistic patentability score using a scoring algorithm, wherein a score of 0 indicates non-patentability and a score of 10 indicates a maximum probability of patentability.

16. The system of claim 10 wherein guiding and constraining an Artificial Intelligence (AI) engine further comprises to perform comparative analysis of the generated detailed description against a historical patent data to demonstrate uniqueness of the generated invention disclosure.

17. The system of claim 1, wherein execution of the code by the computer system causes the computer system to perform operations further comprising:
generating a user-interpretable report summarizing identified one or more novel ideas, retrieved one or more relevant code snippets, full context, and the patentability score.

18. The method of claim 1 wherein the input data includes project documentation, source code, and innovation map.
